(19) United States
(12) Patent Application Publication
(10) Pub. No.: US 2022/0086636 A1
(43) Pub. Date: Mar. 17, 2022

(54) ACCESS POINT AUTHENTICATION BASED ON A DIGITAL CERTIFICATE

(71) Applicant: T-Mobile USA, Inc., Bellevue, WA (US)

(72) Inventors: Jean Cheryl Trakinat, Ewa Beach, HI (US); Mark L. Younge, Golden, CO (US)

(73) Assignee: T-Mobile USA, Inc.

(21) Appl. No.: 17/024,134

(22) Filed: Sep. 17, 2020

(51) Int. Cl. H04W 12/06; H04W 8/24; H04W 12/04; H04W 12/10; H04W 48/08

(52) U.S. Cl. CPC H04W 12/0609; H04W 8/245; H04W 48/08; H04W 12/1008; H04W 12/04

(57) ABSTRACT

A wireless communication system can authenticate a base station based on a validity of a certificate provided by the base station to a mobile device. The certificate can be provided prior to an attach procedure. The mobile device can compare a public key in the certificate to a private key stored on the mobile device. The mobile device can control an attach procedure associated with the mobile device based at least in part on the validity of the certificate.

### BACKGROUND

Cellular communication devices use various network radio access technologies to communicate wirelessly with geographically distributed base stations. Long-Term Evolution (LTE) is an example of a widely implemented radio access technology, which is used within 4^{th}-Generation (4G) communication systems. New Radio (NR) is a newer radio access technology that is used in 5^{th}-Generation (5G) communication systems. Standards for LTE and NR radio access technologies have been developed by the 3rd-Generation Partnership Project (3GPP) for use by wireless communication carriers within cellular communication networks. Note that the terms 4G and LTE are often used interchangeably when referencing 4G systems. In addition, the terms 5G and NR are often used interchangeably when referencing 5G systems.

A user equipment (UE) can receive broadcast messages from a base station in a cellular communication network (e.g., a 4G or 5G network). The UE can access, or attempt to access, the cellular communication network based on the broadcast messages. The UE can obtain information from the broadcast messages and utilize the cellular communication network to provide communication services based on the information.

After the UE obtains the information from the broadcast messages, the UE can register with the cellular communication network. The UE can register with the cellular communication network by performing an attach procedure. During the attach procedure, the UE can provide a subscription identity and obtain a bearer (e.g., evolved packet switched system (EPS) bearer for the 4G network or signaling radio bearer (SRB) for the 5G network) to transmit and receive messages via the cellular communication network.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 schematically illustrates an example network environment for base station authentication, in accordance with various configurations.

FIG. 2 is a diagram illustrating example signaling between a user equipment (UE) and various components of a wireless communication network, such as a 5th generation (5G) mobile network, as described herein.

FIG. 3 is a diagram illustrating example signaling between a user equipment (UE), a security system of a wireless communication network, such as a 5th generation (5G) mobile network, and between the UE and a rogue base station, as described herein.

FIGS. 4A and 4B illustrate examples of various negotiation messages described herein.

FIG. 5 illustrates an example process for a UE communicating with a network that authenticates a base station, in accordance with some examples of the present disclosure.

FIG. 6 is an example of a UE for use with the systems and methods disclosed herein, in accordance with some examples of the present disclosure.

FIG. 7 is an example of a computing device for use with the systems and methods disclosed herein, in accordance with some examples of the present disclosure.

### DETAILED DESCRIPTION

The systems, devices, and techniques described herein are directed to authenticating access points (e.g., base stations) in a telecommunications network. A base station can be authenticated to identify it as an authorized (e.g., trusted) base station. In some examples, the base station can transmit a negotiation message to a user equipment (UE). The negotiation message can include a digital certificate with a public key. The UE can extract and determine a validity of the digital certificate. The UE can perform an attach procedure based on the validity of the digital certificate. Although discussed in the context of a base station, the techniques can be implemented in a base station, a mobile switching center, a macrocell, a microcell, a picocell, a femtocell, a building system, etc.

During authentication, the UE can determine whether the negotiation message is received from an authorized base station or a rogue base station. The UE can determine that the negotiation message is received from the authorized base station based on the digital certificate in the negotiation message. The UE can determine that the negotiation message is received from the rogue base station based on an absence of any digital certificate in the negotiation message or based on an invalid digital certificate in the negotiation message. For example, an invalid digital certificate can be a certificate that is forged certificate, fake, expired, etc.

In embodiments described herein, the UE can determine that the digital certificate is valid or invalid. By way of example, the UE can perform the attach procedure based on the digital certificate being valid. By way of another example, the UE can, based on the digital certificate being invalid, perform the attach procedure and/or output (e.g., display) an invalid indicator. Alternatively, the UE can refrain from performing the attach procedure, based on the digital certificate being invalid. For example, the UE can instead connect to the network via an authorized base station. The UE can, based on being communicatively coupled to the network, 1) transmit an invalid message and/or output (e.g., display) an invalid indicator associated with the invalid digital certificate, and/or 2) provide, to the network (e.g., a mobile network operator associated with the network), information (e.g., location and/or identity information) received from, and/or associated with, the rogue base station.

Various implementations of the present disclosure can be used to solve problems in the technical field of wireless communications. By identifying communications from rogue base stations, UEs and mobile networks can prevent data traffic associated with the UEs from being compromised by nefarious entities associated with the rogue base stations. The identification of the communications from the rogue base stations can prevent information that is proprietary or unique to a user of the UE from being transmitted to the rogue base stations.

Furthermore, mobile networks can prevent charges attributed to the UEs based on activities of the rogue base stations. In addition, by determining identities and locations of rogue base stations, mobile networks can effectively target and neutralize threats from the rogue base stations.

The systems, devices, and techniques described herein can be implemented in a number of ways. References are made to the accompanying drawings that form a part hereof, and in which are shown by way of illustration specific configurations or examples, in which like numerals represent like elements throughout the several figures.

### Illustrative Systems for Authenticating Base Stations in a Network

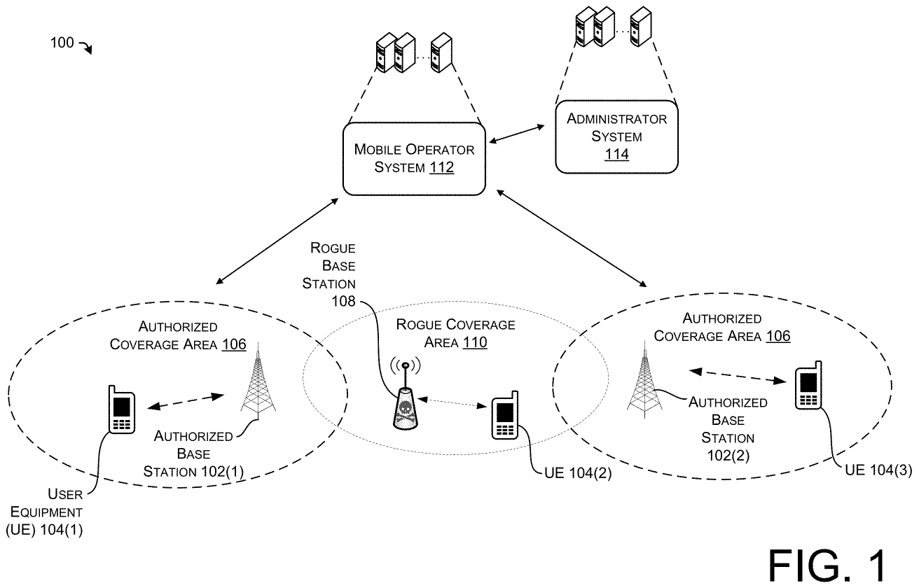

FIG. 1 schematically illustrates an example network environment 100 for base station authentication, in accordance with various configurations. The network environment 100 can include one or more telecommunications networks (e.g., a 4^{th}-Generation (4G) network and/or a 5^{th}-Generation (5G) network) (also referred to herein as network). For example, the network environment 100 can include one or more authorized network devices (e.g., base stations) (BS) 102 associated with a network. The network environment 100 can include one or more authorized coverage areas 106. Each of the authorized coverage areas 106 can be associated with at least one of the base stations 102. Each of the authorized coverage areas 106, for example, can be accessible to one or more user devices 104 (also referred to herein as user equipment (UE) 104 or mobile devices 104).

In some examples, the network environment 100 can include one or more rogue base stations (e.g., a rogue base station 108) and one or more rogue coverage areas (e.g., a rogue coverage area 110). The rogue coverage area 110 can be associated with the rogue base station 108. In some examples, the network environment 100 can include a mobile operator system 112 and an administrator system 114. The mobile operator system 112 can operate the network based on instructions from the administrator system 114. The administrator system 114 may control subscriptions to the network associated with users of the user devices 104.

In various implementations, the rogue base station 108 can be a network device that does not have backhaul capability. The rogue base station 108 can attempt to attach to a UE 104 (e.g., a UE 104(1), (2), or (3)) and receive information associated with the UE 104 until the UE 104 no longer attempts to attach to rogue base station 108 and instead attaches to an authorized base station 102 (e.g., an authorized base station 102(1) or 102(2)). The rogue base station 108 can attempt to disguise its identity from the UE 104 to prevent the UE 104 from detecting that it is not accessing a mobile network via any of the authorized base stations 102. The rogue base station 108 can be any type of device that is not one of the authorized base stations 102. For example, the rogue base station 108 can attempt to attach to the UE 104 to extract data from the UE 104. The data can include, for example, at least one of an International Mobile Subscriber Identity (IMSI) (e.g., an encrypted IMSI or a temporary IMSI) or an International Mobile Equipment Identifier IMEI of the UE 104. The rogue base station 108 can attempt to extract the data by utilizing at least one of passive (e.g., protocol analyzer) and active (e.g., cell-site simulator) capabilities. The rogue base station 108, during active mode operation, can mimic a wireless carrier cell tower in order to connect (e.g. forcefully connect) to the UEs 104 that are in an environment surrounding the rogue base station 108. The rogue base station 108 can be a fixed device or a portable device. For example, the rogue base station 108 can be hand-held or mounted in a vehicle (e.g., an automobile, an airplane, a helicopter, an unmanned aerial vehicles, etc.).

In various implementations, a UE 104 can authenticate an authorized base station 102 based on a digital certificate. As used herein, the term digital certificate and its equivalents, can refer to any certificate associated a certificate authority (CA) (e.g., the mobile operator system 112, on behalf of a service provider (e.g., cellular provider)) utilized to generate the digital certificate. By way of example, the UE 104 can authenticate the authorized base station 102 based on a digital certificate (e.g., base station certificate) associated with the authorized base station 102. The UE 104 can authenticate the authorized base station 102 based on whether the digital certificate that is received by the UE 104 is determined to be valid.

In various implementations, the UE 104 can receive negotiation messages that are broadcast from the authorized base station 102. For example, the UE 104 can receive a negotiation message based on the UE 104 being powered on and performing a cell search procedure. For example, the UE 104 can receive a negotiation message based on a location of the UE 104 changing and being associated with a coverage area of another base station (e.g., a coverage area with a stronger signal from the other base station in comparison to a signal from a current base station). The UE 104 can determine whether a digital certificate received in a negotiation message is valid, based on the UE 104 receiving the negotiation message.

In various implementations, the UE 104 can scan for a master information block (MIB), set a Global Synchronization Channel Number (GSCN), and acquire a Synchronization Signal (SS)/Physical Broadcast CHannel (PBCH) block. The UE 104 can receive the SS/PBCH block, including a Primary Synchronization Signal (PSS) and a Secondary Synchronization Signal (SSS), from the authorized base station 102, and decode the PSS and SSS. The UE 104 can receive a Physical cell identifier (ID) associated with the authorized base station 102, based on the PSS and the SSS.

In various implementations, negotiation messages can be broadcast by the authorized base stations 102 and to the UE 104. The UE 104 can distinguish between negotiation messages that are transmitted by the authorized base stations 102 and negotiation messages that are transmitted by the rogue base station 108. For example, the UE 104 can obtain access, or attempt to obtain access, to the network based on a negotiation message. The negotiation message can include system information.

The system information can include at least one of minimum system information (MSI), remaining minimum system information (RMSI), or other system information (OSI). The MSI can broadcast periodically. Each of the RMSI and the OSI can be broadcast, or provisioned in a dedicated manner, either triggered by the network or upon request from the UE 204.

In various implementations, the negotiation message can include the MSI and be broadcast to the UE 104 as a master information block (MIB). The MSI can include basic information required for initial access by the UE 104 with the authorized base station 102. The UE 104 can communicatively connect to the authorized base station 102 based on information provided in the MIB, by the authorized base station 102.

In various implementations, the negotiation message can include the RMSI and be broadcast to the UE 104 as a system information broadcast 1 (SIB1). The system information in the RMSI can include at least one of cell selection information, a Public Land Mobile Network (PLMN) identifier, a Tracking Area Code (TAC) identifier, a cell identifier, radio access network (RAN) notification information, system information (SI) scheduling information for the OSI, or serving cell information (e.g., information associated with the authorized base station 102).

In various implementations, the negotiation message can include the OSI and be broadcast to the UE 104 as at least one of SIB2-SIB9. For example, the OSI can include information associated with at least one of cell re-selection, a warning or alert notification, or timing information. The UE 104 does not require that the OSI be received prior to accessing the authorized base station 102. For example, the UE 104 can receive the SIBs in the OSI before or after accessing the authorized base station 102.

In various implementations, the UE 104 can determine whether a source of the negotiation message is authorized to communicatively connect with the UE 104. The UE 104 can determine whether the source is authorized, based on the digital certificate associated with the authorized base station 102. The digital certificate associated with the authorized base station 102 can be included within the negotiation message. For example, the negotiation message can be transmitted by the authorized base station 102 and to the UE 104. The negotiation message can include the digital certificate that is signed by the certificate authority based on a request by the authorized base station 102.

In various implementations, the digital certificate can implement a public key infrastructure (PKI) for authenticating the source of the digital certificate. The digital certificate can include a network identity associated with the network, a base station identity associated with the authorized base station 102, security information associated with the base station, an identifier of the certificate authority, a certification (e.g., signature) associated with the certificate authority, an expiration date, a public key, and/or contact information associated with the certificate authority. By way of example, the security information associated with the base station can include a list of PLMNs, access technologies, and/or forbidden networks/areas. A security context utilized by the UE 104 that includes data regarding the security information associated with the base station is established with/after network registration of the UE 104.

The digital certificate can be signed with digital signature technology, which utilizes public key cryptography. The digital certificate that is signed can include a signature associated with the certificate authority. The digital certificate can be generated and signed by the certificate authority, based on a cryptographic key (e.g., a private key stored by a network device (e.g., authorized base station 102) associated with the network). The digital certificate can be utilized to identify the authorized base station 102 that transmits the digital certificate to the UE 104. For example, the UE 104 can identify the digital certificate as being transmitted by the authorized base station 102. The UE 104 can determine, based on the authorized base station 102 being identified, that other devices (e.g., unauthorized base stations (e.g., rogue base stations)) aside from the authorized base station 102 are not associated with the digital certificate.

For example, the digital certificate can be associated with a public key that is generated based on a private key. The public key can be generated by the certificate authority based on a request by the authorized base station 102. The public key can be embedded in the digital certificate (e.g., a digital certificate transmitted by the network and received by one or more authorized base station(s) (e.g., the authorized base station 102), to populate the authorized base station(s) with the digital certificate). The UE 104 can identify the digital certificate as being transmitted by the authorized base station 102, based on the public key. The UE 104 can also determine that other devices (e.g., unauthorized base stations (e.g., rogue base stations)) did not transmit the digital certificate, based on the public key. The public key embedded in the digital certificate can be accessed by any device that receives the negotiation message. However, only devices that include a private key associated with the public key can validate the digital certificate as having been transmitted by the authorized base station 102.

The authorized base station 102 can store the digital certificate or the private key in a secured storage of the authorized base station 102. By way of example, the authorized base station 102 can receive the digital certificate or the private key from a device (e.g., mobile operator system 112) that is associated with an operator (e.g., a maintenance operator associated with the service provider). In another example, the operator can securely log in to the authorized base station 102 with credentials unique to the operator and/or a group of operators. The operator can perform a software update of the authorized base station 102 to update the digital certificate or the private key associated with the authorized base station 102. The digital certificate and/or private key associated with the authorized base station 102 can be updated periodically (e.g., every six months, every year, etc.). For example, the digital certificate and/or the private key can be updated to reduce a likelihood of a rogue base station obtaining the digital certificate and/or the private key and utilizing it to communicatively connect with the UE 104 and or other UEs.

In various implementations, the UE 104 can validate the digital certificate associated with the authorized base station 102 with a digital certificate (e.g., UE certificate) (also referred to herein as mobile device certificate) associated with the UE 104. The digital certificate associated with the UE 104 can be implemented similarly as described herein for the digital certificate associated with the authorized base station 102. By way of example, the digital certificate associated with the UE 104 can be the same as (e.g., identical to) the digital certificate associated with the authorized base station 102. The UE 104 can receive the digital certificate associated with the UE 104 and/or one or more authorized base stations (e.g., authorized base station 102) communicatively coupled to the network. By way of another example, a digital certificate can be associated with the network. The UE 104 can validate the digital certificate as being associated with the authorized base station 102 or the network, based on the private key stored in the UE 104. The UE 104 can determine that the negotiation message including the digital certificate was transmitted by the authorized base station 102, based on the digital certificate being validated.

The UE 104 can store, in a subscriber identity module (SIM) card inserted into the UE 104, the private key associated with the UE 104. By way of example, the UE 104 can receive the digital certificate or the private key by an over-the-air (OTA) transmission from the mobile operator system 112. In another example, a user associated with the UE 104 can insert the SIM card, with the digital certificate or the private key, into the UE 104. In another example, the digital certificate or the private key can be downloaded to the SIM card via a SIM toolkit. The digital certificate and/or private key associated with the UE 104 can be updated periodically (e.g., every six months, every year, etc.). For example, the digital certificate and/or the private key associated with the UE 104 can be updated to at a same time as the digital certificate and/or the private key associated with the authorized base station 102. As a result, the digital certificate and/or the private key associated with the UE 104 respectively match the digital certificate and/or the private key associated with the authorized base station 102, after being updated. However, updating of the digital certificate and/or the private key associated with the UE 104 is not limited to such, and can be performed more frequently or less frequently than the digital certificate and/or the private key associated with the authorized base station 102.

In various implementations, the PKI utilized to implement any of the above described digital certificates can be associated with the mobile operator system 112. The mobile operator system 112 can establish a private public key infrastructure utilized by the authorized base station 102 and/or the UE 104. By way of example, the authorized base station 102 can be associated with the mobile operator system 112 that generates, as a certificate authority, the digital certificate associated with the authorized base station 102. The UE 104 can validate the digital certificate associated with authorized base station 102 that is received within the negotiation message. In another example, the mobile operator system 112 can generate, as the certificate authority, the digital certificate associated with the UE 104. The UE 104 can validate, via a response from the authorized base station 102, the digital certificate associated with UE 104 that is transmitted to, and received by, the authorized base station 102, in a system information request.

In some cases, the digital certificate can be utilized by the UE 104 to determine that the certificate authority associated with the digital certificate is the service provider. The digital certificate can further indicate that the source of the digital certificate is the authorized base station 102 (e.g., gNodeB), which requested the digital certificate from the certificate authority. However, the source of the digital certificate is not limited to such and can include other network elements (e.g., femtocells, macro cells, etc.). Further, the private public key infrastructure utilized to generate the digital certificate is not limited to such and can be established by any entity that provides security for allowing the UE 104 to securely connect with the authorized base station 102. For example, the private public key infrastructure can be established by a third party certificate authority (e.g., Global System for Mobile Communications Association (GSMA), Verisign, Entrust.net, etc.) that is associated with a private key stored in the authorized base station to generate the digital certificate.

In various implementations, the digital certificate can embed data that is encrypted by the certificate authority based on the public key. For example, the data embedded in the digital certificate can include an identifier of the authorized base station 102 as an owner of the public key. The data can include at least one of a name, a street address, or e-mail address associated with the authorized base station 102. The data encrypted with the public key embedded in the digital certificate can only be decrypted using the private key stored in the UE 104. Data encrypted with the private key in the UE 104 can only be decrypted using the public key embedded in the digital certificate.

The UE 104 can transmit, to the authorized base station 102, a system information request that includes the digital certificate that is associated with the UE 104 and received from the certificate authority. The system information request can be utilized by the UE 104 to request the negotiation message that includes the OSI as the at least one of SIB2-SIB9. The system information request can include the digital certificate that is generated to be transmitted by the UE 104 and to the authorized base station 102. The authorized base station 102, but not the rogue base station 108, can determine that the digital certificate in the system information request from the UE 104 is valid. The rogue base station 108 does not have a private key or a digital certificate, with which the digital certificate in the system information request from the UE 104 is associated. As a result, the rogue base station 108 is unable to determine to transmit the OSI to the UE 104.

By way of example, the authorized base station 102 can determine whether the digital certificate in the system information request from the UE 104 is associated with a private key or stored in the authorized base station 102. The authorized base station 102 can transmit the OSI, based on determining that the digital certificate in the system information request from the UE 104 is associated with the private key stored in the authorized base station 102. In another example, the authorized base station 102 can determine whether the digital certificate in the system information request from the UE 104 is associated with (e.g., matches, or corresponds to) a digital certificate stored in the authorized base station 102. The authorized base station 102 can transmit the OSI, based on determining that the digital certificate in the system information request from the UE 104 is associated with the digital certificate stored in the authorized base station 102. By way of example, the digital certificate associated with the authorized base station 102 that is compared with the digital certificate received from the UE 104 in the system information request can be the same as, or different from the digital certificate that is transmitted by the authorized base station 102 in the negotiation message. By way of example, the digital certificate associated with the UE 104 that is transmitted in the system information request can be the same as, or different from, the digital certificate associated with the UE 104 that is compared with the digital certificate received from the authorized base station 102.

The UE 104 can perform an attach procedure to attach to the network based on information provided in the negotiation message. The UE 104 can attach to only the network via single connectivity, or to the 4G and networks via dual connectivity (DC). In some instances, the UE 104 can utilize a non-3GPP technology and/or a 4G or 5G cellular technology to access the network. The UE 104 can determine to perform the attach procedure based on whether the digital certificate that is received by, or transferred from, the UE 104 is valid. For example, the UE 104 can determine to perform the attach procedure based on the digital certificate being determined to be valid. The UE 104 can determine to not perform the attach procedure based on the digital certificate being determined to be invalid.

In various implementations, the authorized base stations 102 can have a Non-Standalone (NSA) configuration or a Standalone (SA) configuration defined by the 3GPP in the 5G/new radio (NR) specification. The NSA configuration can allow the simultaneous use of Long-Term Evolution (LTE) and 5G systems for communications with a communication device. Specifically, NSA uses Dual Connectivity, in which a UE 104 uses both an LTE radio and an NR radio for downlink receptions and uplink transmissions to corresponding LTE and 5G base stations. For instance, a cellular tower including an authorized base station 102 may include both a 4G transceiver (e.g., an eNodeB) by which the authorized base station 102 can establish LTE radio link(s) and a 5G transceiver (e.g., a gNodeB) by which the authorized base station 102 can establish NR radio link(s). In some cases, functions (e.g., transmission intervals, transmission power, etc.) of the 4G transceiver and the 5G transceiver are coordinated by the authorized base station 102. The NSA configuration can provide a connection setup for the UE 104 that includes communicating between a gNodeB and an eNodeB to set up a bearer on the gNodeB based on the UE being capable of being communicatively coupled to a 4G network.

The SA configuration can allow the use of the network for communications with a communication device. For instance, an authorized base station 102 can connect with a UE 104 by utilizing the network without requiring the LTE network. Specifically, the SA configuration uses an end-to-end 5G solution, in which the UE 104 registers with a 5G core network. A control plane and a data plane associated with the UE 104 are served by an NR radio. The SA configuration can provide a connection setup for the UE 104 that includes receiving a random access request by the authorized base station 102 and from the UE 104, setting up a radio resource control (RRC) connection with the UE 104, and performing a Non-Access Stratum (NAS) level authentication to complete a security procedure and set up a default protocol data unit (PDU) session.

In various implementations, the UE 104 that is connected to the network can receive services via that network. Additional public keys and certificates can be provided by the network and utilized after the UE 104 is connected to the network. For example, the public keys can include operator public keys that establish, additionally or alternatively, with the certificates, secure connections between the UE 104 and the network. The additional public keys and certificates, which can be stored on the SIM.

In various implementations, a network can perform a handover for the UE 104 from an authorized base station 102 (e.g., source gNodeB) to which the UE 104 is connected and to a new authorized base station 102 (e.g., target gNodeB). Specifically (e.g., in the context of a 5G network), the network can include an access and mobility management function (AMF) that manages the handover. The AMF can receive a path switch request from the new authorized base station 102 based on a request by the authorized base station 102 to which the UE 104 is connected. The authorized base station 102 can submit the request based on a signal quality of data flowing between the UE 104 and the authorized base station 102. The authorized base station 102 can employ RRC signaling to continuously measure and report on the signal quality.

In various implementations, the UE 104 can display an indication and/or transmit a notification, based on whether the digital certificate is determined to be valid or invalid. For example, the UE 104 can display the indication (e.g., indicator, icon, etc.) on a display of the UE 104. The UE 104 can display the indication having a color (e.g., green) associated with the digital certificate being determined to be valid. The UE 104 can display the indication having a color (e.g., red) associated with the digital certificate being determined to be invalid. The UE 104 can display the indication having a shape (e.g., a “plus” or “thumbs-up” sign) or orientation (e.g., a line that is vertical) associated with the digital certificate being determined to be valid. The UE 104 can display the indication having a shape (e.g., a “minus” or “thumbs-down” sign) or orientation (e.g., a line that is horizontal) associated with the digital certificate being determined to be invalid.

In some instances, the UE 104 can refrain from performing the attach procedure and display the indication, based on the digital certificate being determined to be invalid. Alternatively, the UE 104 can perform the attach procedure and display the indication, based on the digital certificate being determined to be invalid. The digital certificate being determined to be invalid can be associated with the UE 104 performing the attach procedure with the rogue base station 108. The UE 104 that performs the attach procedure notwithstanding the digital certificate being determined to be invalid allows a user associated with the UE 104 to communicate via the network. The indication displayed on the UE 104 informs the user that there is a security risk associated with communicating, based on the UE 104 being communicatively coupled to the rogue base station 108.

In some instances, the UE 104 can display one or more indications (e.g., icons) requesting input from a user associated with the UE 104, based on the digital certificate being determined to be invalid. The UE 104 can display the icons to receive inputs from the user. For example, the UE 104 can display an icon selectable by the user to perform the attach procedure notwithstanding the digital certificate being determined to be invalid. Alternatively or additionally, the UE 104 can display an icon selectable by the user to refrain from performing the attach procedure and display the indication, based on the digital certificate being determined to be invalid. The UE 104 can perform the attach procedure notwithstanding the digital certificate being determined to be invalid, based on input from the user received, selecting the icon to perform the attach procedure. The UE 104 can refrain from performing the attach procedure based on input from the user received, selecting the icon to refrain from performing the attach procedure.

In various implementations, the UE 104 can determine whether a base station from which a negotiation message has been received, or to which a system information request has been transmitted, is valid or invalid, based on an absence of a digital certificate associated with the authorized base station 102. For example, the UE 104 can receive a negotiation message that does not have the digital certificate associated with the authorized base station 102. Alternatively, the UE 104 can transmit a system information request with the digital certificate associated with the UE 104, and not receive a reply. The UE 104 can display an indication and/or transmit a notification similarly as described above for an invalid digital certificate. The UE 104 can also perform an attach procedure or refrain from performing an attach procedure, similarly as described above for an invalid digital certificate. For example, the UE 104 can display the indication and/or transmit the notification along with performing the attach procedure. For example, the UE 104 can display the indication and/or transmit the notification along with refraining from performing the attach procedure.

By way of example, the notification (e.g., the notification indicating the digital certificate is valid or the notification indicating the digital certificate is invalid) can be transmitted from the UE 104 and to a device (e.g., a remote server, a base station (e.g., the authorized base station 102 or another authorized base station) etc.) associated with the service provider. In another example, the notification can be transmitted from the UE 104 and to other UEs. The notification can be transmitted from the UE 104 and to other UEs communicatively coupled to a base station (e.g., the authorized base station 102 or another base station, etc.) associated with the service provider.

In various implementations, the notification indicating that the digital certificate is invalid can include an identifier associated with the rogue base station 108. The device associated with the service provider can store a table of identifiers, with each of the identifiers being associated with a rogue base station. The device of the service provider can send the identifiers to mobile devices subscribing to the service provider. For example, the device of the service provider can receive a query from a mobile device and transmit one or more of the identifiers to the mobile device based on the query.

In various implementations, the certificate authority that provides the private key for the UE 104, can provide private keys for UEs associated with other service providers (e.g., roaming partners (e.g., “Next Best Service provider, Co.,” “123 Service provider, Inc., etc.)). The private keys can enable the UEs associated with the other service providers that are roaming in the network associated with the service provider to validate digital certificates. For example, the UEs associated with the other service providers can validate the digital certificate before performing an attach procedure. The UEs associated with the other service providers that determine the digital certificate is valid can perform an attach procedure with the authorized base station 102. The UEs associated with the other service providers that determine the digital certificate is invalid can refrain from performing the attach procedure. The UEs associated with the other service providers that determine the digital certificate is invalid can perform the attach procedure. The UEs that perform the attach procedure notwithstanding the digital certificate being invalid can display the indication indicating that the digital certificate is invalid.

In various implementations, a digital certificate can be transmitted to update a digital certificate (e.g., a digital certificate associated with a UE or a base station) that is securely stored in a device (e.g., base station). The updated digital certificate can be transmitted based on an amount of time exceeding a threshold amount of time, since an initial digital certificate (e.g., a digital certificate utilized, established, or generated prior to the updated digital certificate) was transmitted. For example, the initial digital certificate can expire after the amount of time exceeds the threshold amount of time. In another example, the initial digital certificate can expire based on partial or complete failure of a device (e.g., a SIM card, a storage of a base station, a storage of a UE, etc.) on which the initial digital certificate is stored. The updated digital certificate can be transmitted based on an amount of time exceeding a threshold amount of time, since the initial digital certificate was activated and/or established. By way of example, the initial digital certificate can be activated based on the device on which the initial digital certificate is stored, being powered on. In another example, the initial digital certificate can be activated based on the initial digital certificate being established and transmitted by the certificate authority. In another example, the initial digital certificate can be activated based on the initial digital certificate being received by the device and from the certificate authority. In another example, the initial digital certificate can be activated based on a request for the initial digital certificate being received from the device and by the certificate authority.

Therefore, and as described herein, exchanging digital certificates between UEs and base stations can enhance security for the UEs. The UEs that are attempting to communicatively connect to base stations can transmit or receive the digital certificates associated with a certificate authority. A UE that has just been powered on or that is undergoing a handover can authenticate a base station before attaching to it.

The digital certificate received by the UE can be generated by, and associated with, the mobile operator system 112. The digital certificate can be transmitted to the UE and by the base station that receives the digital certificate from the mobile operator system 112. The UE can authenticate the base station based on the digital certificate identifying the base station as an authorized base station. Since the digital certificate is unique to the base station, the UE can validate the digital certificate as being transmittable by only the base station. The UE is able to avoid being connected to rogue base stations that transmit an invalid digital certificate or that do not transmit a digital certificate at all. The security of the UE attaching to, and operating within, the cellular network is improved since the UE can avoid attaching to the rogue base stations.

Furthermore, the digital certificates that identify authorized base stations from which they are sent provide advantages over existing technology. Because security associations between the UE and network entities (e.g., base stations) are established after attaching to the base stations, the UEs are unable to avoid attempting attach procedures with the rogue base stations. The UEs in various implementations of the present disclosure that receive and validate the digital certificates can authenticate base stations before performing the attach process. The UEs are able to prevent data from being captured, utilized, and shared by the rogue base stations.

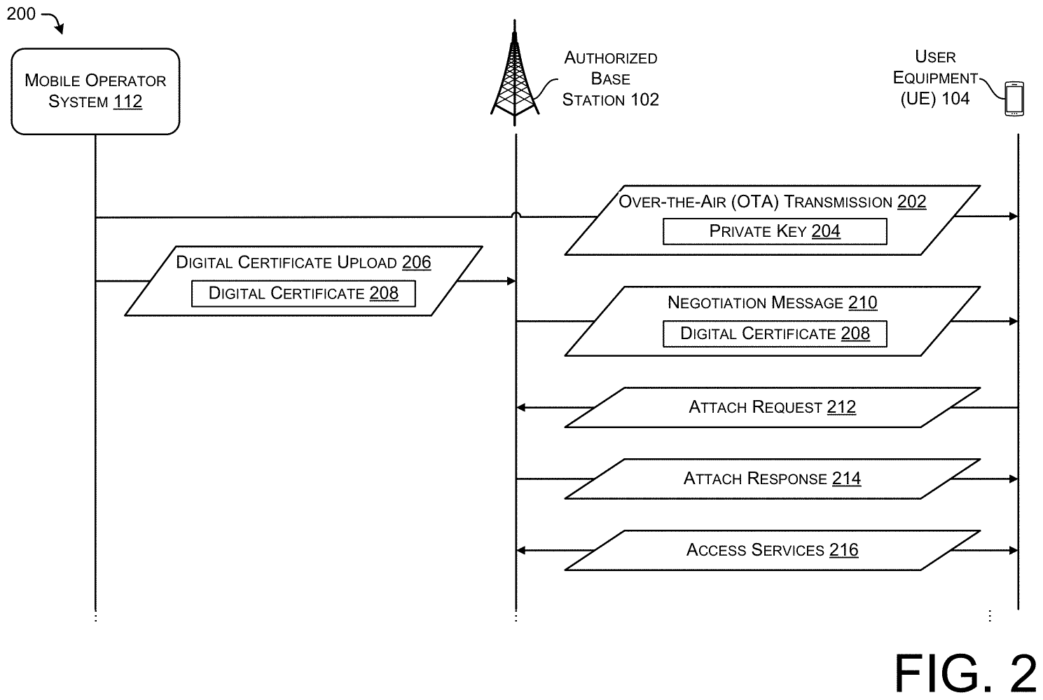

FIG. 2 is a diagram illustrating example signaling between a user equipment (UE) and various components of a wireless communication network, such as a 5th generation (5G) mobile network, as described herein. As illustrated, the signaling 200 includes interactions between the authorized base station 102, the UE 104, and the mobile operator system 112, which are described above with reference to FIG. 1. In the example illustrated in FIG. 2, the authorized base station 102, the UE 104, and the mobile operator system 112 are separate devices connected by one or more communication networks.

The mobile operator system 112 can transmit an over-the-air (OTA) transmission 202 to the UE 104, via an authorized base station communicatively coupled to the network. The OTA transmission 202 can include a private key 204 associated with a service provider (e.g., cellular provider). In some examples, the OTA transmission 202 can include, alternatively or additionally to the private key 204, a digital certificate associated with a service provider. The private key 204 can be stored on the UE 104. For example, the private key 204 can be stored in the SIM card inserted in the UE 104. The private key 204 can be utilized to sign the digital certificate that includes a public key and that is received from the authorized base station 102.

The mobile operator system 112 can transmit a digital certificate upload 206 to the authorized base station 102. The digital certificate upload 206 can include a digital certificate 208 signed by a private key associated with the service provider. In some examples, the digital certificate 208 can include, alternatively or additionally to the digital certificate 208, the private key associated with the authorized base station 102. The private key can be utilized to generate the digital certificate 208 to identify the authorized base station 102. The digital certificate 208 can be stored in the authorized base station 102.

The authorized base station 102 can transmit a negotiation message 210. For example, the negotiation message 210 can be broadcast from the authorized base station 102 and to the UE 104. In some instances, an amount of time between the OTA transmission 202 and the digital certificate upload 206, an amount of time between the OTA transmission 202 and the negotiation message 210, and/or an amount of time between the digital certificate upload 206 and the negotiation message 210 can be any amount of time determined by the authorized base station 102 and/or the network. The negotiation message 210 can include the digital certificate 208. The UE 104 can determine whether the digital certificate 208 is valid, based on the UE 104 receiving the digital certificate 208 via the negotiation message 210.

The UE 104 can transmit an attach request 212 (e.g., a radio resource control (RRC) random access request (e.g., RRCSetupRequest)) to the authorized base station 102, based on the digital certificate 208 being determined to be valid. The authorized base station 102 can set up a RRC connection with the UE 104. The authorized base station 102 can perform a Non-Access Stratum (NAS) level authentication to complete a security procedure and set up a default protocol data unit (PDU) session.

The authorized base station 102 can transmit an attach response 214 (e.g., RRCSetup) to the UE 104. The attach response 214 can indicate that the authorized base station 102 is ready to continue with the attach procedure to perform (e.g., provide) access services 216 based on the attach procedure and/or network communications services based on a registration procedure being successfully performed. In some examples, the attach procedure can include exchanging additional messages between the authorized base station 102 and the UE 104. The additional messages can include, for example, a setup complete message (e.g., RRCSetupComplete) transmitted by the UE 104 and to the authorized base station 102, a security mode command message (e.g., SecurityModeCommand) transmitted by the authorized base station 102 and to the UE 104, a security mode complete message (e.g., SecurityModeComplete) transmitted by the UE 104 and to the authorized base station 102, a reconfiguration message (e.g., RRCReconfiguration) transmitted by the authorized base station 102 and to the UE 104, and/or a reconfiguration complete message (e.g., RRCReconfigurationComplete) transmitted by the UE 104 and to the authorized base station 102.

In some examples, the UE 104 can perform a registration procedure with the AMF, based on the attach procedure being successfully performed. The UE 104 can, for example, perform the registration procedure by transmitting a registration request message to the AMF, via the authorized base station 102. The registration procedure can include receiving, by the UE 104 and via the authorized base station 102, a registration accept message from the AMF, based on the registration request message. The registration procedure can include transmitting, by the UE 104 and via the authorized base station 102, a registration complete message to the AMF, based on the registration accept message. The registration complete message can indicate that the UE 104 has successfully updated itself after receiving a configured Network Slice Selection Assistance Information (NSSAI) for a serving PLMN, a mapping of a configured NSSAI, a Network Slicing Subscription Change Indication, and/or Closed Access Group (CAG) information. The UE 104 can receive network services 216 based on the registration complete message, which indicates, coincides with, or is preliminary to, the registration procedure being successfully performed.

The authorized base station 102 and/or the UE 204 can perform access services 216, based on the attach procedure being successfully performed. For example, the services 216 performed by the authorized base station 102 and the UE 204 can include exchanging communication messages. The access services 216 can be performed by the UE 104, or by cooperation between one or more of the mobile operator system 112, the authorized base station 102, and the UE 104. In some examples, the services 216 can include mobility management, registration (e.g., the registration procedure), call set-up, and/or handover.

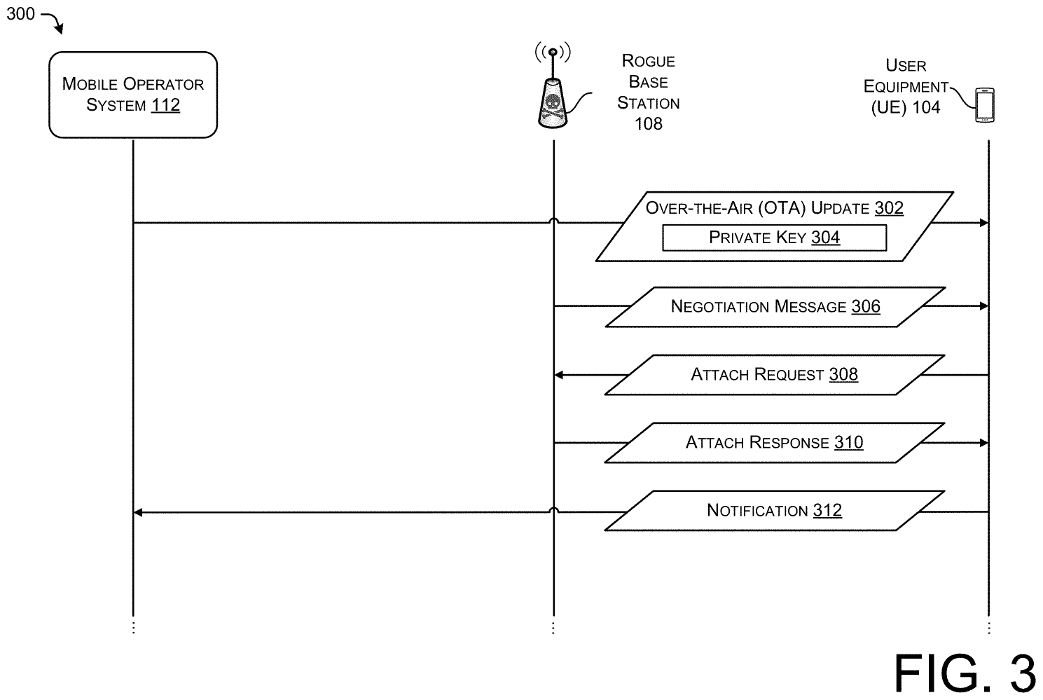

FIG. 3 is a diagram illustrating example signaling between a user equipment (UE), a security system of a wireless communication network, such as a 5th generation (5G) mobile network, and between the UE and a rogue base station 108, as described herein. As illustrated, the signaling 300 includes interactions between the UE 104 and the rogue base station 108, and between the UE 104 and the mobile operator system 112, which are described above with reference to FIG. 1. In the example illustrated in FIG. 3, the UE 104, the rogue base station 108, and the mobile operator system 112 are separate devices connected by one or more communication networks.

The mobile operator system 112 can transmit an over-the-air (OTA) transmission 302 to the UE 104. For example, the UE 104 can receive the OTA transmission 302 from an authorized base station (e.g., authorized base station 102) prior to arriving in the vicinity of rogue base station 108. The OTA transmission 302 can include a private key 304 associated with a service provider (e.g., cellular provider). In some examples, the OTA transmission can include, alternatively or additionally to the private key 304, a digital certificate associated with a service provider. The private key 304 can be stored on the UE 104. For example, the private key 304 can be stored in a subscriber identity module (SIM) card inserted in the UE 104. The private key 204 can be utilized to sign the digital certificate that includes a public key and that is received from the authorized base station 102.

The rogue base station 108 can transmit a negotiation message 306. For example, the negotiation message 306 can be broadcast from the rogue base station 108 to the UE 104. The UE 104 can determine whether the negotiation message 306 include a digital certificate that is invalid or does not include any digital certificate. The UE 104 can determine that the rogue base station 108 is not an authorized base station, based on the UE 104 receiving the negotiation message 306 that includes the invalid digital certificate or does not include any digital certificate.

The UE 104 can perform an attach procedure that includes transmitting an attach request 308 and/or receiving an attach response 310. For example, the attach procedure performed between the UE 104 and the rogue base station 108 can be similar to the above described attach procedure performed between the UE 104 and the authorized base station 102. The UE can transmit the attach request 308 (e.g., a random access request) to the rogue base station 108, notwithstanding the negotiation message 306 including the invalid digital certificate or the negotiation message 306 missing a digital certificate. Prior to performing the attach procedure, the UE 104 can measure signal strengths of negotiation messages transmitted by one or more base stations (e.g., the authorized base station 102 and the rogue base station 108). For example, the UE 104 can perform the attach procedure with the rogue base station 108 based on a signal strength of a negotiation message (e.g., negotiation message 306) being larger than (e.g., two, three, ten, times, etc., as large as) a signal strength of one or more other negotiation messages received by other base stations. The rogue base station 108 can set up a radio resource control (RRC) connection with the UE 104.

The rogue base station 108 can transmit the attach response 310 to the UE 104, based on the attach request 308. The attach response 310 can indicate (e.g., falsely or fraudulently indicate) that the rogue base station 108 is ready to perform access services based the attach procedure being successfully performed. For example, the attach procedure and/or at least a portion of a simulated registration procedure can be performed by the rogue base station 108 and/or the UE 104, prior to performing services. The simulated registration procedure can be performed similar to the above described registration procedure, based on the rogue base station 108 being disguised at least partially as an authorized base station.

The rogue base station 108 and the UE 104 can perform services based on the attach response 310. For example, the rogue base station 108 and the UE 104 can exchange communication messages. The services can include simulated and/or disguised services by the rogue base station 108, which are indistinguishable by the UE 104 from services that would be performed with an authorized base station. For example, the simulated and/or disguised services can be temporarily or permanently indistinguishable by the UE 104. The rogue base station 108 can perform the services 312 with the UE 104 to retrieve information from the UE 104. The rogue base station 108 can perform the services 312 without detection by the UE 104 that the services 312 are not being performed with an authorized base station. For example, the services 312 can include receiving, by the rogue base station 108 and from the UE 104, a registration request message, a request from the UE 104 to set up a voice call, a request from the UE 104 to set up a video call, and/or a request from the UE 104 to establish a data connection. The services 312 can include a response by the rogue base station 108 to one or more of the above describe requests received from the UE 104.

The UE 104 can connect, via an authorized base station instead of the rogue base station 108, to the mobile operator system 112. The UE 104 can transmit a notification 312 to the mobile operator system 112. The UE 104 can refrain from performing, with the rogue base station 108, any of one or more portions of the attach procedure, such as transmitting the attach request 308, receiving the attach response 310, and performing the services 312, and transmit the notification 312 indicating the digital certificate is invalid or missing. Alternatively, the UE 104 can perform the attach procedure with the rogue base station 108, subsequently communicatively connect, via an authorized base station, to the mobile operator system 112, and transmit the notification 312 indicating the digital certificate is invalid or missing.

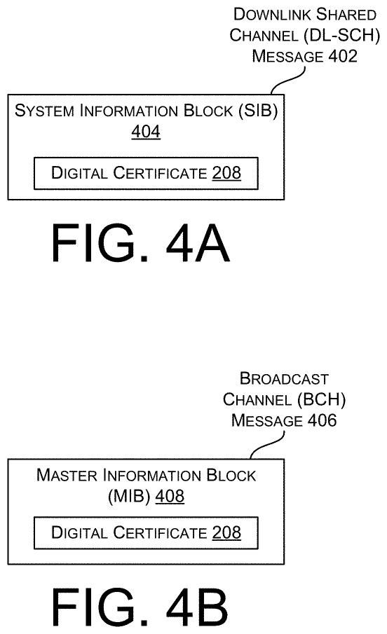

FIGS. 4A and 4B illustrate examples of various negotiation messages described herein. FIG. 4A illustrates an example of a negotiation message that can be a downlink shared channel (DL-SCH) message 402. Alternatively, in some instances, the negotiation message can be a control channel message. The DL-SCH message 402 can be included in a negotiation message transmitted by a cellular base station, for instance. The DL-SCH message 402 illustrated in FIG. 4A can include a system information block (SIB) 404. In various cases, the SIB 404 can include a digital certificate 208. For instance, the digital certificate 208 can be included in one or more parameters of the SIB 404.

The SIB 404 can include, for example, an SIB1. The SIB1 can include cell selection information, a Public Land Mobile Network (PLMN) identifier, a Tracking Area Code (TAC) identifier, a cell identifier, radio access network (RAN) notification information, system information (SI) scheduling information for the OSI, and serving cell information.

The SIB 404 can include, for example, an SIB2. The SIB2 can include cell re-selection information, associated with a serving cell (e.g., a cell associated with authorized base station 102).

The SIB 404 can include, for example, an SIB3. The SIB3 can include information about a serving frequency and intra-frequency neighboring cells relevant for cell re-selection, including cell re-selection parameters common for a frequency as well as cell specific re-selection parameters.

The SIB 404 can include, for example, an SIB4. The SIB4 can include information about other new radio (NR) frequencies and inter-frequency neighboring cells relevant for cell re-selection, including cell re-selection parameters common for a frequency as well as cell specific re-selection parameters.

The SIB 404 can include, for example, an SIB5. The SIB5 can include information about E-UTRA frequencies and E-UTRA neighboring cells relevant for cell re-selection, including cell re-selection parameters common for a frequency as well as cell specific re-selection parameters.

The SIB 404 can include, for example, an SIB6. The SIB6 can include an Earthquake & Tsunami Warning System (ETWS) primary notification.

The SIB 404 can include, for example, an SIB7. The SIB7 can include an ETWS secondary notification.

The SIB 404 can include, for example, an SIB8. The SIB8 can include California Multiple Award Schedules (CMAS) warning notification.

The SIB 404 can include, for example, an SIB9. The SIB9 can include information related to a Global Positioning System (GPS) time and Coordinated Universal Time (UTC).

Therefore, and as described herein, the negotiation message can be transmitted as the DL-SCH message. The DL-SCH message can include any of the SIB1-SIB9, which can include the digital certificate. The digital certificate can be included in a message based on a type of security associated with the digital certificate. By way of example, the digital certificate being included in the SIB1 provides extensive security since additional SIBs can be ignored if the digital certificate in the SIB1 is invalid. In another example, the digital certificate being included in the SIB4 provides customized security regarding notifications related to the CMAS. Although these messages are utilized less often than SIB1, for example, the digital certificate being included in the SIB4 can be utilized to send a notification if the digital certificate is invalid. Different digital certificates associated with different responses can be provided in each SIB. For example, the UE can perform the attach process while sending out a notification, based on the digital certificate in the SIB1 being determined to be invalid. Whereas, the UE can refrain from performing the attach process while sending out a notification, based on the digital certificate in the SIB4 being determined to be invalid.

FIG. 4B illustrates a second example of a negotiation message, which can be a broadcast channel (BCH) message 406. The BCH message 406 can be included in a negotiation message transmitted by a cellular base station, for instance. The BCCH message 406 can include a master information block (MIB) 408. The digital certificate 208 can be included in the MIB 408. For instance, the digital certificate 208 can be included in one or more parameters of the MIB 408.

The MIB 408 can include a System Frame Number (SFN), critical information for the reception of the SIB1, a Cell barred flag, and an Intra frequency reselection allowed flag.

Therefore, and as described herein, the negotiation message can be transmitted as the BCH message. BCH message can include the MIB, which can include the digital certificate. The digital certificate can be included in a message based on a type of security associated with the digital certificate. By way of example, the digital certificate being included in the MIB provides extensive security since SIB1-SIB9 can be ignored if the digital certificate in the MIB is invalid. Different digital certificates associated with different responses can be provided in the MIB and in each SIB. For example, the UE can perform the attach process while sending out a notification, based on the digital certificate in the MIB being determined to be invalid. Whereas, the UE can refrain from performing the attach process while sending out a notification, based on the digital certificate in the SIB1 being determined to be invalid.

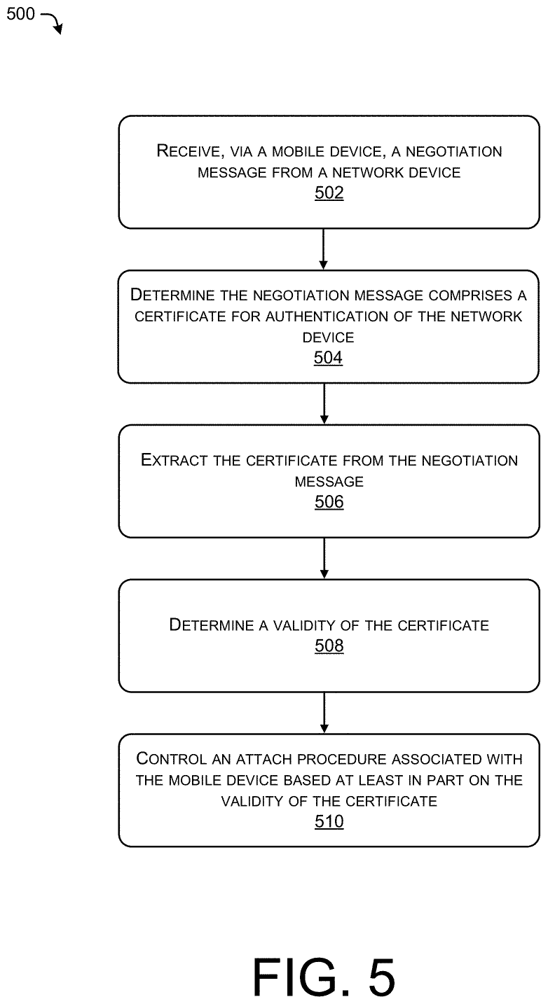

FIG. 5 illustrates an example process for a UE communicating with a network that authenticates a base station, in accordance with some examples of the present disclosure. The process is illustrated as a logical flow graph, each operation of which represents a sequence of operations that can be implemented in hardware, software, or a combination thereof. In the context of software, the operations represent computer-executable instructions stored on one or more computer readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

The example process 500 can be performed by a UE (e.g., UE 104) or another component, in connection with other components discussed herein.

At operation 502, the process can include receiving, via a mobile device (e.g., UE 104), a negotiation message from a network device. For example, the negotiation message can be received as an MIB, an SIB1, or any of SIB2-SIB9.

At operation 504, the process can include determining the negotiation message comprises a certificate for authentication of the network device. For example, the UE 104 can determine whether a source of the negotiation message is authorized to communicatively connect with the UE 104, based on whether the negotiation message includes the certificate.

At operation 504, the process can include extracting the certificate from the negotiation message. If the negotiation message includes the certificate, the UE 104 can extract the certificate.

At operation 504, the process can include determining a validity of the certificate. If the negotiation message includes the certificate, the UE 104 can determine whether the source is authorized based on the certificate being valid or invalid.

At operation 504, the process can include controlling an attach procedure associated with the mobile device based at least in part on the validity of the certificate. The UE 104 can attach to only a 5G network via single connectivity, or to a 4G network and the 5G network via dual connectivity (DC). The UE 104 can determine to perform the attach procedure based on whether the digital certificate that is received by the UE 104 is valid.

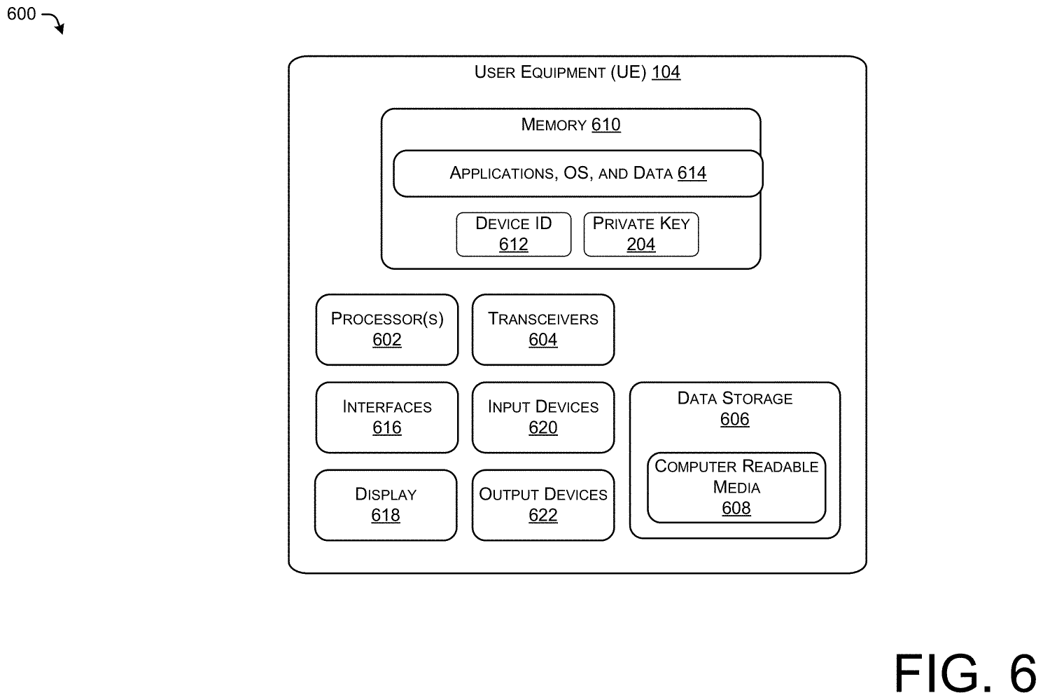

FIG. 6 is an example of a UE for use with the systems and methods disclosed herein, in accordance with some examples of the present disclosure. The UE 104 can comprise one or more processors 602, one or more transmit/receive antennas (e.g., transceiver antennas) 604, and a data storage 606. The data storage 606 can include a computer readable media 608 in the form of memory and/or cache. The processor(s) 602 can be configured to execute instructions, which can be stored in the computer readable media 608 or in other computer readable media accessible to the processor(s) 602. In some configurations, the processor(s) 602 is a Central Processing Unit (CPU), a Graphics Processing Unit (GPU), or both CPU and GPU, or any other sort of processing unit. The transceiver antenna(s) 604 can transmit signals to the authorized base station 102, and receive signals from the authorized base station 102.

The UE 104 can comprise a memory 610. The memory 610 can be implemented within, or separate from, the data storage 606 and/or the computer readable media 608. The memory 610 can also include any available physical media accessible by a computing device to implement the instructions stored thereon. For example, the memory 610 can include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 104.

The memory 610 can store several modules, such as instructions, data stores, and so forth that are configured to execute on the processor(s) 602. For instance, the memory 610 can store a device identifier (ID) 612 and a private key 204. In configurations, the computer readable media 608 can also store one or more applications 614 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., the base station 102, other UEs, etc.). The applications 614 can also include third-party applications that provide additional functionality to the UE 600.

Although not illustrated in FIG. 6, the UE 600 can also comprise various other components, e.g., a battery, a charging unit, one or more network interfaces 616, an audio interface, a display 618, a keypad or keyboard, and one or more input devices 620, and one or more output devices 622.

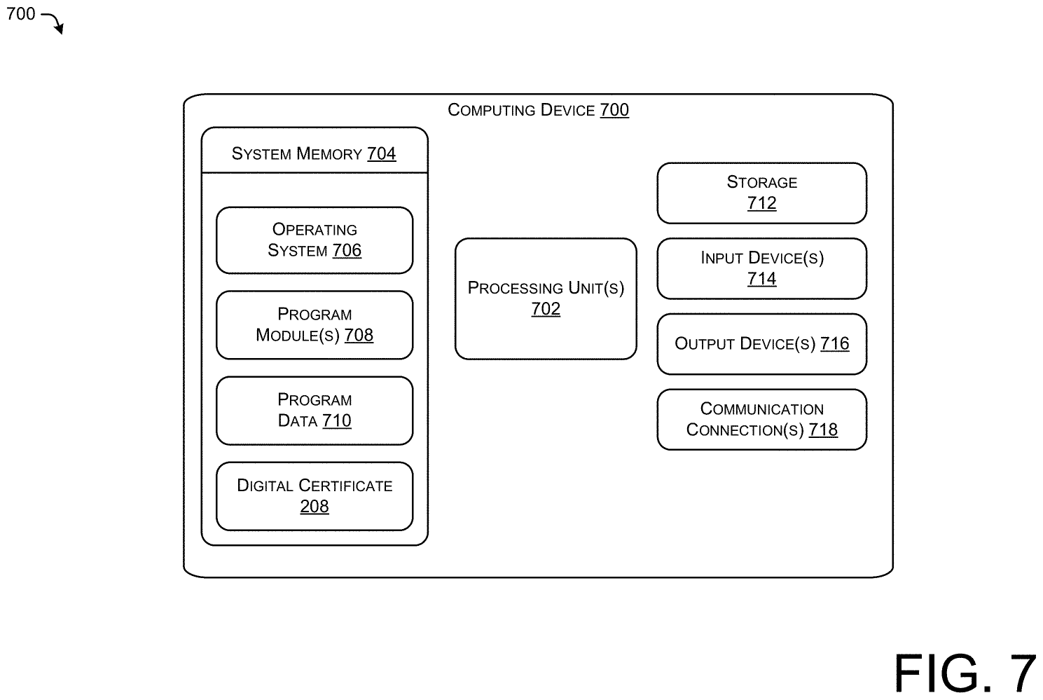

FIG. 7 is an example of a computing device 700 for use with the systems and methods disclosed herein, in accordance with some examples of the present disclosure. The computing device 700 can be used to implement various components of a core network, a base station, and/or any servers, routers, gateways, administrative components, etc. that can be used by a communication provider. One or more computing devices 700 can be used to implement the coverage area(s) 106, for example. One or more computing devices 700 can also be used to implement base stations and other components.

In various embodiments, the computing device 700 can include one or more processing units 702 and system memory 704. Depending on the exact configuration and type of computing device, the system memory 704 can be volatile (such as RAM), non-volatile (such as ROM, flash memory, etc.) or some combination of the two. The system memory 704 can include an operating system 706, one or more program modules 708, and can include program data 710. The system memory 704 can include a digital certificate 208. The system memory 704 can be a secure storage. In some instances, at least a portion of the system memory 704 can include secure storage. The secure storage can prevent unauthorized access to data stored in the secure storage. For example, data stored in the secure storage can be encrypted or accessed via a security key and/or password.

The computing device 700 can also include additional data storage devices (removable and/or non-removable) such as, for example, magnetic disks, optical disks, or tape. Such additional storage is illustrated in FIG. 7 by storage 712.

Non-transitory computer storage media of the computing device 700 can include volatile and nonvolatile, removable and non-removable media implemented in any method or technology for storage of information, such as computer readable instructions, data structures, program modules, or other data. The system memory 704 and storage 712 are all examples of computer readable storage media. Non-transitory computer readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 700. Any such non-transitory computer readable storage media can be part of the computing device 700.

In various embodiment, any or all of the system memory 704 and storage 712 can store programming instructions which, when executed, implement some or all of the function functionality described above as being implemented by components of the mobile operator system 112 and/or the administrator system 114.

The computing device 700 can also have one or more input devices 714 such as a keyboard, a mouse, a touch-sensitive display, voice input device, etc. The computing device 700 can also have one or more output devices 716 such as a display, speakers, a printer, etc. can also be included. The computing device 700 can also contain one or more communication connections 718 that allow the device to communicate with other computing devices.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

What is claimed is:

1. A method comprising:
receiving, at a mobile device, a negotiation message from a network device;
determining that the negotiation message comprises a certificate for authentication of the network device;
extracting the certificate from the negotiation message;
determining a validity of the certificate; and
controlling an attach procedure associated with the mobile device and the network device based at least in part on the validity of the certificate.

2. The method of claim 1, wherein:
the network device is a base station;
the certificate comprises a base station certificate; and
determining the validity comprises:
accessing a mobile device certificate; and
determining the base station certificate was generated by a certificate authority associated with the base station, based at least in part on the mobile device certificate.

3. The method of claim 1, wherein the certificate is associated with at least one of the network device or a service provider associated with the network device.

4. The method of claim 1, wherein the negotiation message comprises at least one of a master information block (MIB) or a system information block (SIB).

5. The method of claim 1, wherein the certificate is a first certificate; and
wherein determining the validity comprises:
receiving a second certificate via at least one of an over-the-air (OTA) message or a locally connected operator device message; and
authenticating the first certificate based at least in part on the second certificate.

6. The method of claim 1, wherein determining the validity of the certificate comprises determining the certificate is invalid, and
wherein controlling the attach procedure further comprises:
receiving data input via a display associated with the mobile device; and
based at least in part on the data, allowing the mobile device to perform the attach procedure notwithstanding the certificate being invalid.

7. The method of claim 1, wherein determining the validity of the certificate comprises determining the certificate is invalid, and
wherein controlling the attach procedure further comprises refraining from allowing the mobile device to perform the attach procedure based at least in part on the certificate being invalid.

8. The method of claim 1, wherein determining the validity of the certificate comprises:
determining the certificate is valid;
allowing the mobile device to perform the attach procedure; and
performing services by the mobile device.

9. The method of claim 1, wherein the validity of the certificate is determined based at least in part on a public key in the certificate.

10. The method of claim 1, wherein the validity of the certificate is determined based at least in part on a private key stored in the mobile device.

11. A system comprising:
one or more processors;
a memory; and
one or more components stored in the memory and executable by the one or more processors to perform operations comprising:
receiving, at a mobile device, a negotiation message from a network device;
determining that the negotiation message comprises a certificate for authentication of the network device;
extracting the certificate from the negotiation message;
determining a validity of the certificate; and
controlling an attach procedure associated with the mobile device and the network device based at least in part on the validity of the certificate.

12. The system of claim 11, wherein:
the network device is a base station;
the certificate comprises a base station certificate; and
determining the validity comprises:
accessing a mobile device certificate; and
determining the base station certificate was generated by a certificate authority associated with the base station, based at least in part on the mobile device certificate.

13. The system of claim 11, wherein the certificate is associated with at least one of the network device or a service provider associated with the network device.

14. The system of claim 11, wherein the negotiation message comprises at least one of a master information block (MIB) or a system information block (SIB).

15. The system of claim 11, wherein determining the validity of the certificate comprises determining the certificate is invalid, and
wherein controlling the attach procedure further comprises:
receiving data input via a display associated with the mobile device; and
based at least in part on the data, allowing the mobile device to perform the attach procedure.

16. The system of claim 11, wherein the certificate comprises a network identity associated with a network by which the mobile device and a base station communicate, a base station identity associated with the base station, and security information associated with the base station.

17. A system comprising:
one or more processors;
a memory; and
one or more components stored in the memory and executable by the one or more processors to perform operations comprising:
receiving, at a mobile device, a certificate for authentication of a network device;
determining a validity of the certificate; and
controlling an attach procedure associated with the mobile device and the network device based at least in part on the validity of the certificate.

18. The system of claim 17, wherein:
the network device is a base station;
the certificate comprises a base station certificate; and
determining the validity comprises:
accessing a mobile device certificate; and
determining the base station certificate was generated by a certificate authority associated with the base station, based at least in part on the mobile device certificate.

19. The system of claim 17, wherein the certificate is associated with at least one of the network device or a service provider associated with the network device.

20. The system of claim 17, the operations further comprising:
transmitting a notification that the network device is invalid to a remote server, the notification utilized by the remote server to subsequently inform other mobile devices of the network device.
